(19) United States
(12) Patent Application Publication
(10) Pub. No.: US 2008/0057433 A1
(43) Pub. Date: Mar. 6, 2008

(54) ADHESIVE PRIMER

(75) Inventors: Christine D. ANDERSON, Hamilton (CA); Guiqin SONG, Milton (CA); T. Brian MCANENEY, Burlington (CA)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/468,620

(22) Filed: Aug. 30, 2006

(51) Int. Cl. G03G 15/20

(52) U.S. Cl. 430/126.1; 524/260

(57) ABSTRACT

Described herein is an adhesive primer used with xerographic printing and imaging systems, wherein the adhesive primer comprises at least one latex emulsion, water, at least one amino alcohol or at least one alkali base and at least one surfactant and may be applied in an inline process.

### BACKGROUND

Described herein is an adhesive primer used with electrostatographic printing and imaging systems. The disclosed adhesive primer possesses, for example, excellent compatibility with photoreceptors and substrates having fuser oil thereon. Specifically, disclosed herein is an adhesive primer for coating a printed or xerographic image prior to an adhesive being applied thereon, wherein the adhesive primer comprises at least one latex emulsion, water, at least one amino alcohol or at least one alkali base and at least one surfactant.

The adhesive primer disclosed herein promotes the adhesion of an adhesive to a substrate that may be at least partially covered by a release agent.

### REFERENCES

In a typical imaging device, a light image of an original to be printed or copied is recorded in the form of a latent image upon a photosensitive member, and the latent image is subsequently rendered visible by the application of resin and pigment particles, or toner. The visible toner image is then in a loose powdered form and can be easily disturbed or destroyed. The toner image is usually fixed or fused upon a support, which may be a support sheet such as plain paper.

To ensure and maintain good release properties of the fuser roll, it has become customary to apply release agents to the fuser roll during the fusing operation. Typically, these materials are applied as thin films of for example, nonfunctional silicone oils or mercapto-or amino-functional silicone oils, to prevent toner offset.

U.S. Pat. No. 4,029,827 discloses the use of polyorganosiloxanes having mercapto functionality as release agents.

U.S. Pat. No. 4,101,686 and U.S. Pat. No. 4,185,140 disclose polymeric release agents having functional groups such as carboxy, hydroxy, epoxy, amino, isocyanate, thioether, or mercapto groups.

U.S. Pat. No. 5,157,445 discloses toner release oil having a functional organopolysiloxane.

U.S. Pat. No. 5,512,409 teaches a method of fusing thermoplastic resin toner images to a substrate using amino functional silicone oil over a hydrofluoroelastomer fuser member.

U.S. Pat. No. 5,516,361 teaches a fusing member having a thermally stable hydrofluoroelastomer surface and having a polyorgano T-type amino functional oil release agent. The oil has predominantly monoamino functionality per active molecule to interact with the hydrofluoroelastomer surface.

U.S. Pat. No. 5,531,813 discloses a polyorgano amino functional oil release agent having at least 85% monoamino functionality per active molecule to interact with the thermally stable hydrofluoroelastomer surface of the fuser member.

U.S. Pat. No. 5,716,747 discloses the use of fluorine-containing silicone oils for use on fixing rollers with outermost layers of ethylene tetrafluoride perfluoro alkoxyethylene copolymer, polytetrafluoroethylene and polyfluoroethylenepropylene copolymer.

U.S. Pat. No. 5,747,212 discloses an amino functional oil.

U.S. Pat. No. 6,183,929 discloses a release agent comprising an organosiloxane polymer containing amino-substituted or mercapto-substituted organosiloxane polymers and a nonfunctional organosiloxane polymer.

U.S. Pat. No. 4,029,827 describes the use of polymeric release agents having functional groups, which interact with a fuser member to form a thermally stable, renewable self-cleaning layer having good release properties for electroscopic thermoplastic resin toners.

### SUMMARY

It is desired to apply an adhesive to a substrate that may be at least partially covered by a release agent. The adhesive primer disclosed herein promotes adhesion of an adhesive to a substrate that may be at least partially covered by a release agent.

In embodiments, disclosed is an adhesive primer applied to a toner imaged substrate at least partially covered by a release agent, wherein the adhesive primer comprises at least one latex emulsion, water, at least one amino alcohol or at least one alkali base, and at least one surfactant.

In further embodiments, disclosed is a method comprising applying a toner image onto a substrate, fusing the toner image to the substrate whereby a release agent at least partially covers the substrate having a toner image thereon, applying an adhesive primer to the partially covered substrate, and applying an adhesive onto the adhesive primer such that the adhesive is firmly adhered to the substrate having the toner image thereon, wherein the adhesive primer comprises at least one latex emulsion, water, at least one amino alcohol or at least one alkali base, and at least one surfactant.

In yet further embodiments, disclosed is a bound article comprising a first recording medium having a toner image thereon, an adhesive primer over the first recording medium, an adhesive over the adhesive primer, and a second recording medium bound to the first recording medium via the adhesive primer and the adhesive, wherein the adhesive primer comprises at least one latex emulsion, water, at least one amino alcohol or at least one alkali base, and at least one surfactant.

### EMBODIMENTS

As explained above, it is known to apply release agents to the fuser roll to provide the necessary release of a substrate from the fuser roll after the toner image has been formed on the substrate. Release agents are known to one of ordinary skill in the art and include those release agents disclosed in U.S. Publication No. 2006/0008727, U.S. Publication No. 2004/0185272 and U.S. Publication No. 2003/0108737, each of which is incorporated therein by reference in its entirety. As used herein, “substrate” refers to any media that may be printed on, such as paper, pre-printed forms, transparency, cardboard, etc.

Release agents are useful for releasing a substrate from a fuser roll found in an imaging device, such as in an electrophotographic device or an electrostatographic device. In such devices some release agent may remain on the toner image, which may cover any portion of the substrate, and on the substrate itself. In other words, the release agent may at least partially cover a substrate having no toner image or a substrate having a toner image thereon. “Partially” refers to the release agent covering from, about 1 percent to about 100 percent of the substrate, such as from about 10 percent to about 100 percent or from about 10 percent to about 90 percent of the substrate.

Xerographic prints thus may include thereon a release agent or silicone fuser oil due to the printing process. The amino functional fuser oil may chemically bond to the surface of the prints because of the fusing process at high pressure and high temperature. The surface free energy (SFE) of the xerographic prints may thus dramatically drop from a range of higher than 30 mN/m² to a range of from about 8 mN/m² to about 30 mN/m². Generally, commercially available hot melt adhesives bind to substrates having as SFE higher than 30 mN/m².

The presence of a release agent on the substrate, with or without a toner image thereon, can thus be detrimental to the ability of an adhesive to adhere to the substrate. This is particularly problematic when the substrate is to be laminated or coated with a hot melt adhesive, such as an adhesive used in bookbinding. The release agent may also prevent materials utilizing adhesives for adhering, for example a POST-IT® note, from adhering to the substrate.

Disclosed herein is an adhesive primer that promotes the adhesion of an adhesive to a substrate having a tonier image thereon, wherein the substrate may be at least partially covered by a release agent. The adhesive primer may also promote adhesion of an adhesive a substrate having no toner image or a substrate having a toner image without being covered by a release agent.

The adhesive primer disclosed herein is useful in many publishing applications involving processes such as bookbinding using hot melt adhesives, for example, to provide adhesion of the pages to the spine of the book, magazine or the like. Lowered glue adherence, i.e., gluability, appears to stem from the extremely low surface tension of the release agent typically used in xerographic print engines. In addition, glue adhesion is generally worse on substrates having a low SFE.

Applying the adhesive primer as described herein to the substrate prior to the application of any adhesives provides a solution to the difficulty of differential SFE and/or tension because it may (1) effectively seal any release agent and/or substrate energy, and (2) provide a uniform surface which offers improved adhesion for the adhesive.

As described herein, typical release agents used in releasing a substrate from a fuser roll in an imaging device include poly-organofunctional siloxanes, such as amino-functional silicone oils, such as methyl aminopropyl methyl siloxane, ethyl aminopropyl methyl siloxane, benzyl aminopropyl methyl siloxane, dodecyl aminopropyl methyl siloxane, aminopropyl methyl siloxane, and the like. The adhesive primer disclosed herein is particularly suitable for use in conjunction with application utilizing amino functional silicone oils, but may also be used with other non-functionalized or functionalized release agents.

Described herein is an adhesive primer that may be applied to a substrate having no toner image or a substrate having a toner image thereon, either of which is at least partially covered by a release agent as described herein. By applying the adhesive primer, the SFE of the substrate having no toner image or having a toner image thereon is increased to the desired range of above 30 mN/m². Increasing the SFE of the substrate allows an adhesive to be effectively applied to the substrate having no toner image or having a toner image thereon.

Suitable hot melt adhesives that may be used herein include commercially available hot melt adhesives, such as polyethylene, poly(ethylene/vinyl acetate), polystyrene, polyamide, a polyolefin based polymer, polyester, phenol-formaldehyde resin, etc., of a homopolymer or a block copolymer based hot melt adhesives.

The adhesive primer composition comprises at least one latex emulsion, water, at least one amino alcohol or at least one alkali base, and at least one surfactant. The adhesive primer may optionally contain one or more viscosity modifiers.

The adhesive primer is desirably free of or substantially free of ammonia and thus does not negatively affect the photoreceptor used in xerographic and similar devices. Substantially free of ammonia refers to, for example, less than 0.5% by weight of ammonia, such as less than 0.3% or less than 0.1% by weight of ammonia, being present in the adhesive primer or an overall weight bases of the adhesive primer.

At least one latex emulsion refers to, for example, from 1 to about 10 latex emulsions that are combined, such as from 1 to about 5 latex emulsions or from 1 to about 3 latex emulsions, in the adhesive primer composition. The overall latex emulsion mixture may have a glass transition temperature (T_{g}) of, for example, from about 30° C. to about 95° C., such as from about 35° C. to about 85° C. or from about 35° C. to about 70° C. To achieve this range of T_{g}, more than one latex emulsion may be used. In other words, various latex emulsions may be combined to achieve the desired T_{g}. For example, a latex emulsion having a T_{g} lower than the desired final T_{g} may be employed with additional latex emulsion(s) having a higher T_{g}, or a latex emulsion having a T_{g} higher than the desired T_{g}, such as from about 95° C. to about 150° C., or more. Any combination of one or more latex emulsions may be combined, as long as the desired T_{g} range for the overall latex emulsion mixture is achieved. The T_{g} may be measured by differential scanning calorimetry (DSC) using, for example, a DSC 2920 (obtained from TA Instruments) or dynamic mechanical analysis using, for example, a Rheometric Scientific RSAII Solid Analyzer.

In embodiments, the latex emulsion may include styrene/acrylic emulsions, acrylic emulsions, polyester emulsions or mixtures thereof.

Examples of acrylic latex emulsions include poly(alkyl methacrylate-alkyl acrylate), poly(alkyl methacrylate-aryl acrylate), poly(aryl methacrylate-alkyl acrylate), poly(alkyl methacrylate-acrylic acid), and poly(alkyl acrylate-acrylonitrile-acrylic acid); the latex contains a resin selected from the group consisting of poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), combinations thereof and the like.

Examples of styrene/acrylic latex emulsions include poly(styrene-alkyl acrylate), poly(styrene-1,3-diene), poly(styrene-alkyl methacrylate), poly(styrene-alkyl acrylate-acrylic acid), poly(styrene-1,3-diene-acrylic acid), poly(styrene-alkyl methacrylate-acrylic acid), poly(styrene-alkyl acrylate-acrylonitrile-acrylic acid), and poly(styrene-1,3-diene-acrylonitrile-acrylic acid); the latex contains a resin selected from the group consisting of poly(styrene-butadiene), poly(methylstyene-butadiene), poly(styrene-isoprene), poly(methylstyrene-isoprene), poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylononitrile-acrylic acid), combinations thereof and the like.

Examples of specific acrylic latex emulsions suitable for use herein include RHOPLEX® HA-12 & RHOPLEX® I-2074 available from Rohm & Haas, Co. Examples of styrene/acrylic latex emulsions include ACRONAL S728, ACRONAL NX4533 and ACRONAL S888S from BASF. Water based acrylic or styrene/acrylic emulsions may be self-crosslinking and/or alkali soluble and supplied on the acid side (un-neutralized).

Examples of suitable polyester latex emulsions include polyethylene-terephthalate, polypropylene-terephthalate, polybutylene-terephthalate, polypentylene-terephthalate, polyhexalene-terephthalate, polyheptadene-terephthalate, polyoctalene-terephthalate, polyethylene-sebacate, polypropylene sebacate, polybutylene-sebacate, polyethylene-adipate, polypropylene-adipate, polybutylene-adipate, polypentylene-adipate, polyhexalene-adipate, polyheptadene-adipate, polyoctalene-adipate, polyethylene-glutarate, polypropylene-glutarate, polybutylene-glutarate, polypentylene-glutarate, polyhexalene-glutarate, polyheptadene-glutarate, polyoctalene-glutarate polyethylene-pimelate, polypropylene-pimelate, polybutylene-pimelate, polypentylene-pimelate, polyhexalene-pimelate, polyheptadene-pimelate, poly(propoxylated bisphenol-fumarate), poly(propoxylated bisphenol-succinate), poly(propoxylated bisphenol-adipate), poly(propoxylated bisphenol-glutarate), combinations thereof and the like.

In embodiments, the adhesive primer may include one or more latex emulsions in a total amount from about 40 weight percent to about 95 weight percent, such as from about 50 weight percent to about 90 weight percent or from about 60 weight percent to about 90 weight percent, of the adhesive primer. If one or more latex emulsions is utilized, each latex emulsion may be present in an amount from about 1 weight percent to about 94 weight percent of the adhesive primer, such as from about 5 weight percent to about 90 weight percent or from about 10 weight percent to about 85 weight percent of the adhesive primer. Each latex emulsion may be present in any amount as long as the total amount of the latex emulsion in the adhesive primer is within the desired range and has the desired T_{g}.

The adhesive primer disclosed herein further includes at least one amino alcohol or at least one alkali base.

At least one amino alcohol refers to, for example, from 1 to about 10 amino alcohols that are combined, such as from 1 to about 5 amino alcohols or from 1 to about 3 amino alcohols, in the adhesive primer composition. An amino alcohol refers, for example, to a compound having amino group(s) associated with an alkyl alcohol or an aryl alcohol. For example, the alkyl alcohol may include from about 1 to about 36 carbon atoms, such as from about 1 to about 30 carbon atoms or from about 1 to about 15 carbon atoms. An alkyl alcohol may be linear, branched or cyclic and includes, for example, methanol, ethanol, propanol, isopropanol and the like. Aryl alcohols may include from about 6 to 36 carbon atoms, such as from about 6 to about 30 carbon atoms or from about 6 to about 15 carbon atoms. An aryl alcohol includes, for example, cyclobutyl, cyclopentyl, phenyl and the like. One or more amino groups refers to, for example, from about 1 to about 10 amino groups, such as from 1 to about 5 amino groups or from 1 to about 3 amino groups.

Examples of the amino alcohol include 2-aminoethanol, 2-aminopropanol, 2-aminobutanol, 2-aminohexanol, 2-methyl-2-aminoethanol, 2-methyl-2-aminoethanol, 2-methyl-2-aminopropanol, 2-ethyl-2-aminoethanol, 2-ethyl-2-aminopropanol, 1-amino-2-propanol, 1-amino-2-butanol, 1-amino-2-pentanol, 3-amino-2-2butanol, 2-amino-1,3-propanediol, 2-amino-2-ethyl-1,3-propanediol, 3-amino-1,2-propanediol and tris-(hydroxymethyl)-aminomethane, triisopropanolamine and 2-dimethylamino-2-methyl-1-propanol and similar substances.

At least one alkali base refers to, for example, from 1 to about 10 alkali bases that are combined, such as from 1 to about 5 alkali bases or from 1 to about 3 alkali bases, in the adhesive primer composition. Examples of alkali bases include KOH, LiOH, NaOH and the like.

The adhesive primer may include at least one amino alcohol or alkali base in an amount from about 1 weight percent to about 5 weight percent, such as from about 1 weight percent to about 4 weight percent or from about 1 weight percent to about 3 weight percent, of the adhesive primer.

The adhesive primer may further include at least one surfactant. At least one surfactant refers to, for example, from 1 to about 10 surfactants that are combined, such as from 1 to about 5 surfactants or from 1 to about 3 surfactants, in the adhesive primer composition. This additional surfactant is not inclusive of the surfactant that may be included in the original latex emulsions. The surfactant added to the adhesive primer may be included to assist in adjusting the surface tension of the adhesive primer as more fully discussed below. Suitable surfactants for use herein include anionic surfactants, nonionic surfactants, silicone surfactants and fluorosurfactants.

Anionic surfactants may include sulfosuccinates, disulfonates, phosphate esters, sulfates, sulfonates, and mixtures thereof.

Examples of nonionic surfactants include polyvinyl alcohol, polyacrylic acid, isopropyl alcohol, acetylenic diols, octyl phenol ethoxylate, branched secondary alcohol ethoxylates, perfluorobutane sulfonates and alcohol alkoxylates.

Silicone surfactants are well known in the art and include polyether modified poly-dimethyl-siloxane and the like.

Examples of fluorosurfactants suitable for use herein may include ZONYL® FSO-100 (E.I. Du Pont de Nemours and Co., Wilminigton, Del.), having the formula RfCH₂CH₂O(CH₂CH₂O)xH, wherein Rf=F(CF₂CF₂)y, x=0 to about 15, and y=1 to about 7, NOVEC® FC4432, FC4430, and the like, available from 3M, and the like.

The adhesive primer composition may include one or more surfactants in a total amount from about 0.001 weight percent to about 5 weight percent, such as from about 0.001 weight percent to about 4 weight percent or from about 0.01 weight percent to about 3 weight percent, of the adhesive primer. The total amount of surfactants in the adhesive primer refers to the surfactant added to the adhesive primer composition, not to any surfactant found in the latex emulsions. In other words, the amount of total surfactant is not inclusive of any surfactant that may be included in the latex emulsions.

Considering surfactants present in the latex emulsions, the total amount of surfactants in the adhesive primer may be in the range of from about 1 to about 8, such as from about 2 to about 7 or from about 3 to about 5 weight percent, of the adhesive primer composition. If one or more surfactants is utilized, each surfactant may be present in an amount from about 0.01 weight percent to about 7.99 weight percent of the adhesive primer, such as from about 0.1 weight percent to about 7.9 weight percent or from about 1 weight percent to about 7 weight percent of the adhesive primer.

The adhesive primer disclosed herein may optionally include one or more rheological or viscosity modifiers. One or more viscosity modifiers refers to, for example, from 1 to about 10 viscosity modifiers that are combined, such as from 1 to about 5 viscosity modifiers or from 1 to about 3 modifiers, in the adhesive primer composition. Examples of viscosity modifiers include alkali-swellable acrylic thickeners, such as ACRYSOL® ASE-60 (available from Rohm & Haas), ACRYSOL® ASE-75, RHEOLATE® 450 and RHEOLATE® 420, and associative thickeners, such as ELEMENTIS RHEOLATE® 255, RHEOLATE® 216 and RHEOLATE® 1.

The adhesive primer may optionally include one or more viscosity modifiers in an amount from about 0.01 weight percent to about 8 weight percent, such as from about 0.01 weight percent to about 5 weight percent or from about 0.1 weight percent to about 5 weight percent, of the adhesive primer.

The adhesive primer incorporates water in an amount from about 30 weight percent to about 80 weight percent, such as from about 35 weight percent to about 75 weight percent or from about 40 weight percent to about 70 weight percent, of the adhesive primer.

In embodiments, further conventional optional additives may include coalescing aids, wax, anti-foaming agents, matting agents, UV absorbers, biocides, crosslinking agents, and the like.

In embodiments, the adhesive primer may include optional additives known, to those skilled in the art in an amount from about 0.1 weight percent to about 8 weight percent, such as from about 0.1 weight percent to about 10 weight percent or from about 1 weight percent to about 10 weight percent, of the adhesive primer.

Examples of waxes suitable for use herein include functionalized waxes, polypropylenes, polyethylenes and natural waxes. Wax emulsions are available from Michaelman Inc., Daniels Products Company, Eastman Chemical Products, Inc., and Sanyo Kasei K.K. Commercially available polyethylenes usually possess a molecular weight of from about 1,000 to about 1,500, while the commercially available polypropylenes are believed to have a molecular weight of from about 4,000 to about 5,000. Examples of functionalized waxes include amines, amides, imides, esters, quaternary amines, carboxylic acids or acrylic polymer emulsions. Examples of polyethylene waxes include JONWAX 26 & 28 available from BASF, and chlorinated polypropylenes and polyethylenes commercially available from Allied Chemical, Petrolite Corporation and BASF. Examples of natural waxes include carnauba and licowaxes available from Strahl & Pitsch. When utilized, the wax may be present in the adhesive primer in an amount from about 1 weight percent to about 8 weight percent, such as from about 1 weight percent to about 6 weight percent or from about 2 weight percent to about 5 weight percent, of the adhesive primer composition.

Matting agents may be used in the formulation and may include silicas, silica gels, aluminum silicates and waxes, as described above, and the like.

Dyes that are invisible to the naked eye but detectable when exposed to radiation outside the visible wavelength range (such as ultraviolet or infrared radiation), such as dansyl-lysine, N-(2-aminoethyl)-4-amino-3,6-disulfo-1,8-dinaphthalimide dipotassium salt, N-(2-aminopentyl)-4-amino-3,6-disulfo-1,8-dinaphthalimide dipotassium salt, Cascade Blue ethylenediamine trisodium salt (available from Molecular Proes, Inc.), Cascade Blue cadaverine trisodium salt (available from Molecular Proes, Inc.), bisdiazinyl derivatives of 4,4′-diaminostilbene-2,2′-disulfonic acid, amide derivatives of 4,4′-diaminostilbene-2,2′-disulfonic acid, phenylturea derivatives of 4,4′-disubstituted stilbene-2,2′-disulfonic acid, mono-or di-naphthyltriazole derivatives of 4,4′-disubstituted stilbene disulfonic acid, derivatives of benzithiazole, derivatives or benzoxazole, derivatives of benzimidazole, derivatives of coumarin, derivatives of pyrazolines containing sulfonic acid groups, 4,4′-bis(triazin-2-ylamino)stilbene-2,2′-disulfonic acids, 2-(stilben-4-yl)naphotriazoles, 2-(4-phenylstilben-4-yl)benzoxazoles, 4,4-bis(triazo-2-yl)stilbene-2,2′-disulfonic acids, 1,4-bis(styrl)biphenyls, 1,3-diphenyl-2-pyrazolines, bis(benzazol-2-yl)derivatives, 3-phenyl-7-(triazin-2-yl)coumarins, carbostyrils, naphthalimides,3,7-diaminodibenzothiophen-2,8-disulfonic acid-5,5-dioxide, other commercially available materials, such as C.I. Fluorescent Brightener No. 28 (C.I. 40622), the fluorescent series Leucophor B-302, BMB (C.I. 290), BCR, BS, and the like (available from Leucophor), and the like, are also suitable for use as a colorant.

In addition, suitable colorants that can be used herein include one or more fluorescent colorants, which can be pigment, dye, mixtures of dyes, mixtures of pigments, mixtures of dyes and pigments, and the like. For example, suitable fluorescent pigment concentrates are disclosed in, for example, U.S. Pat. No. 4,911,830, the entire disclosure of which is incorporated herein by reference, and suitable fluorescent colorants are disclosed in, for example, U.S. Pat. Nos. 4,243,694 and 5,554,480, the entire disclosures of which are incorporated herein by reference. Suitable inorganic fluorescent pigments can be prepared, for example, by adding trace amounts of activating agents such as copper, silver and manganese to high purity sulfides of heavy metals or alkaline earth metals such as zinc sulfide, which are used as raw materials, and calcining them at a high temperature. Suitable organic fluorescent pigments can be prepared, for example, by dissolving fluorescent dyes in the vehicles of synthetic resins or ones prepared by dyeing the dispersed matters of fine resin particles obtained by emulsion polymerization or suspension polymerization with fluorescent dyes. The synthetic resins can include vinyl chloride resins, alkid resins and acrylic resins, and the fluorescent dyes include C.I acid yellow 7, C.I. basic red 1 and the like.

Suitable fluorescent dyes include those belonging to the dye families known as rhodamines, fluoresciens, coumarins, napthalimides, benzoxanthenes, acridines, azos, and the like. Suitable fluorescent dyes include, for example, Basic Yellow 40, Basic Red 1, Basic Violet 11, Basic Violet 10, Basic Violet 16, Acid Yellow 73, Acid Yellow 184, Acid Red 50, Acid Red 52, Solvent Yellow 44, Solvent Yellow 131, Solvent Yellow 85, Solvent Yellow 135, solvent Yellow 43, Solvent Yellow 160 and Fluorescent Brightener 6. Suitable fluorescent pigments include those available from Day-Glo Color Corp. of Cleveland, Ohio, such as aurora pink T-11 and GT-11, neon red T-12 rocket red T-13, fire orange T-14 or GT-14N, blaze orange T-15 or GT-15N, arc yellow T-16, saturn yellow T-17N, corona magenta GT-21 and GT-17N, and the like.

An anti-foaming agent, such as BYK-019 & BYK-028, water based polysiloxane anti-foaming agents available from Dempsey Corp., or the equivalent may optionally be added to the primer.

Coalescing aids, if present in the adhesive primer, may include polyglycol ethers, such as Butyl Carbitol & Dowanol DPnB (Dow Corp). The coalescing aid may be present in the adhesive primer in an amount from 0 weight percent to about 8 weight percent, such as from about 0 weight percent to about 6 weight percent or from about 2 weight percent to about 5 weight percent, of the adhesive primer.

UV absorbs may be included in the adhesive primer composition and may include benzophenone derivatives (such as SANDUVOR® 3041), hydroxyphenyltriazine (SANDUVOR® TB-01), CIBAFAST® HLiq, and CIBA TINUVIN® 1130 and zinc oxide.

Biocides may be incorporated into the adhesive primer composition and may include organosulfur, organohalogens, phenates, chlorophenates, heterocyclic nitrogen compounds, organic esters, quaternary ammonium compounds, inorganic boron compounds.

Crosslinking agents, which may optionally be present in the adhesive primer, include thermosetting resins, such as CYMEL® 303, and oxalic acid.

The viscosity of the adhesive primer, prior to drying, may be from about 50 cP to about 750 cP, such as from about 100 cp to about 700 cP or from about 100 cP to about 650 cP at room temperature (approximately 22-27° C.). The static surface tension of the adhesive primer prior to drying may be from about 15 mN/m to about 40 mN/m, such as from about 20 mN/m to about 40 mN/m or from about 20 mN/m to about 30 mN/m.

The adhesive primer may be applied to any type of substrate, such as, for example, paper, including wherein the substrate has a residue of fuser-oil (such as functionalized silicone oil), to completely wet the surface. The substrate can contain additives including anti-curl compounds, such as, for example, trimethylolpropane, biocides, humectants, chelating agents, and mixtures thereof and any other optional additives known in the art for enhancing the performance and/or value of the toner and/or substrate.

The adhesive primer may be applied to the substrate at any suitable time after image formation and after the image is substantially fused. For example, the adhesive primer may be applied to the substrate immediately after the image is fused, such as in an inline coating apparatus where the image printing and overcoating are conducted by the same printing device, or after a short or long delay after printing, such as in an offline coating apparatus where the image printing and overcoating are conducted by different printings devices. In embodiments, the adhesive primer disclosed herein may be applied to a toner image 50 milliseconds to 120 seconds such as from about 75 milliseconds to about 110 seconds or from about 90 milliseconds to about 100 seconds after the toner has substantially been fused to the recording medium, for example, paper, cardboard, preprint forms and the like. In embodiments, the adhesive primer disclosed herein is applied to the recording medium having a toner image thereon after it exits the fuser of a xerographic machine. The adhesive primer composition disclosed herein may be used on toner images totally, partially or not at all covered with fuser oil. If the toner image is at least partially covered with fuser oil, the static surface tension of the adhesive prime may substantially match the static surface tension of the fuser oil.

Furthermore, the adhesive primer may be applied over the entire substrate, the entire image, parts of the substrate, or parts of the image. For example, the composition may be applied to both imaged areas and non-imaged areas, it can be applied only to imaged areas, or it can be applied only to non-imaged areas. In embodiments, the adhesive primer is applied over the entire substrate, including toner imaged and non-imaged areas, to provide more uniform surface properties. The toner-based image on the substrate may have been previously prepared by any suitable xerographic process comprising, for example, generating an electrostatic image, developing the electrostatic image with toner, and transferring the developed toner-based image to a substrate, or modifications thereof, known in the art of xerography.

More specifically, methods for generating images coated with the adhesive primer discloser herein comprise: generating an electrostatic latent image on a photoconductive imaging member, developing the latent image with toner, transferring and fusing the developed electrostatic image to a substrate, and coating the substrate or parts thereof and/or image or parts thereof with an adhesive primer. Development of the image may be achieved by a number of methods known in the art, such as, for example, cascade, touchdown, powder cloud, magnetic brush, and the like. Transfer of the developed image to the substrate may be by any method, including those making use of corotron or a biased roll. The fixing may be performed by means of any suitable method, such as, for example, flash fusing, heat fusing, pressure fusing, vapor fusing, and the like. Suitable imaging methods, devices, and systems are known in the art and include those described in U.S. Pat. Nos. 4,585,884, 4,584,253, 4,563,408, 4,265,990, 6,180,308, 6,212,347, 6,187,499, 5,966,570, 5,627,002, 5,366,840; 5,346,795, 5,223,368, and 5,826,147, the entire disclosures of which are incorporated herein by reference.

Liquid film coating devices can be used for applying the adhesive primer composition and/or the adhesive, including spray coaters, roll coaters, rod coaters, blades, wire bars, air-knives, curtain coaters, slide coaters, doctor-knives, screen coaters, gravure coaters, such as, for example, offset gravure coaters, slot coaters, and extrusion coaters. Such devices may be used in a known manner, such as, for example, direct and reverse roll coating, offset gravure, curtain coating, lithographic coating, screen coating, and gravure coating. In embodiments, coating of the adhesive primer is accomplished using a two or three roll coater. Typical adhesive primer deposition levels, expressed as mass per unit area, can be from about 1 g/m² to about 10 g/m², such as about 5 g/m².

The adhesive primer may be used with a xerographic engine producing fused toner image at least partially covered with fuser oil, such as functionalized and nonfunctionalized silicone oil. If a functionalized silicone oil is used then the functional group may be an amino group, a mercapto group or the like. Fuser oil may be deposited in amount of from about 0 to about 25 microliter per copy, such as from about 0 to about 20 microliters or from about 1 to about 18 microliters per copy using and 8½ inch by 11 inch page. The adhesive primer formulation disclosed herein is able to uniformly coat over any portion of fused toner-based images that have been covered with a fuser oil. This adhesive primer may also be effectively used with xerographic machines or offset prints free of fuser oil. The uniform coating over either type of image is achieved as a result of the blend of surfactants, viscosity modifiers and latex emulsion(s).

“Substantially match” refers to, for example, the difference between the static surface tension of the adhesive primer and the static surface tension of the fuser oil being about 25 percent or less, such as from about 0.001 percent to about 20 percent or from about 0.01 percent to about 15 percent.

The toner image discussed herein may be formed from any suitable toner or developer, for example including emulsion/aggregation (EA) toner and toner produced by a mechanical process. Suitable EA toners that may be used with the adhesive primer disclosed herein include polyester EA toners, such as those disclosed in U.S. Pat. No. 5,593,807, U.S. Pat. No. 5,290,654. U.S. Pat. No. 5,308,734, and U.S. Pat. No. 5,370,963, each of which is incorporated herein by reference in their entirety. In embodiments, the toner may be a mechanical toner, such as those disclosed in U.S. Pat. No. 6,850,725, which is incorporated herein by reference in its entirety.

The adhesive primer dries upon application to the substrate and on exposure to heat and/or air. Application of UV light is not necessary to dry the adhesive primer. However a UV lamp may be used to dry the adhesive primer, for example when used as a heat source.

The adhesive primer dries at slightly elevated temperatures, for example above 15° C. In embodiments, the adhesive primer dries at temperatures from about 15° C. to about 90° C., such as from about 20° C. to about 80° C. or from about 25° C. to about 60° C. The speed at which the adhesive primer may be fully dried and hardened is from about 0 ft/min. to about 100 ft/min, such as from about 10 ft/min. to about 100 ft/min. or from about 20 ft/min. to about 100 ft/min.

When applied, for example when the adhesive primer is wet, the adhesive primer may be applied to have a thickness from about 2 μm to about 10 μm, such as from about 2 μm to about 8 μm from about 3 m to about 7 μm. When the adhesive primer has dried, it has a thickness of from about 0.5 μm to about 5 μm, such as from about 0.5 μm to about 5 μm or from about 1μm to about 3 μm.

In embodiments, the adhesive is applied to the substrate having the adhesive primer thereon immediately after application of the adhesive primer. In further embodiments, the adhesive is applied to the substrate having the adhesive primer thereon once the adhesive primer is completely dried, for example, when the adhesive primer is dry to the touch. The adhesive may be applied to the substrate by any known method as described herein. In still further embodiments, the adhesive may be associated with another substrate, such as book binding material, a POST-IT®, and the like, and may be used to form a bound article.

In embodiments, the adhesive primer disclosed herein may be prepared by first blending the latex emulsion, or more than one latex emulsion, as described above. The additional water and surfactant may then be independently added to the latex emulsion mixture, and then mixed. As discussed above, more than one surfactant may be pre-blended before being added to the aqueous mixture. After the one or more surfactants is blended with the latex emulsion mixture, a viscosity modifier, as described above, may optionally be added to achieve the viscosity levels disclosed herein. Each of these steps takes place at room temperature, for example, from about 22° C. to about 27° C.

The amino alcohol or alkali base is added to the mixture. This may be done by, for example, drop-wise addition of the amino alcohol or alkali base. Sufficient amino alcohol or alkali base is added such that the pH of the adhesive primer composition is from about 8 to about 10, such as from about 8 to about 9.5 or from about 8.5 to about 9.5. If the viscosity of the adhesive primer is adversely affected by the addition of the amino alcohol or alkali base, another viscosity modifier may be added to further adjust the viscosity to the levels discussed above.

### EXAMPLES

An example of an aqueous overcoat varnish which satisfies the unique parameters of digital printing consists of:

TABLE 1
Formulation Components

| | | Amount |
|---|---|---|
| Component | Chemical Composition | (wt %) |
| Rohm & Haas | Styrene/Acrylic Emulsion | 64.9 |
| RHOPLEX ® HA-12 | | |
| Rohm & Haas | Styrene/Acrylic Emulsion | 22.0 |
| RHOPLEX ® I-2074 | | |
| Water | Water | 0.5 |
| Neutralizing Agent | Sodium Hydroxide | 2.7 |
| | (50% Solution) | |
| Air Products | AP 504: Butanedioic acid, 1,4-Bis(2- | 0.8 |
| SURFYNOL ® 504/ | ethylhexyl) ester, Sodium Salt | |
| 3M NOVEC ® FC | FC4432: Perfluorobutane sulfonate | |
| 4432 | | |
| Rohm & Haas | Alkali swellable, crosslinked, acrylic | 3.6 |
| ACRYSOL ® ASE- | thickener (50% 0 Solution) | |
| 60 | | |
| Butyl Carbitol | Diethylene Glycol Monobutyl Ether | 2.5 |
| BYK-028 | Mix of polymers and polysiloxanes | 0.5 |

The RHPLEX® HA-12 and RHOPLEX® I-2074 were blended together with medium shear (about 500 RPM) for approximately thirty minutes. The surfactants (SURFYNOL® 504 and NOVEC® FC4432, pre-blended in a 90:10 ratio) were added to the latex emulsions and allowed to mix for approximately an additional thirty minutes. Next the water and defoamer, BYK-028, available from Dempsey Corp., were added while being stirred and mixed for about thirty minutes. After sufficient mixing, the ACRYSOL® ASE-60 was added to the formulation and allowed to blend for about thirty minutes. At the allotted time, a pH meter was inserted into the mixture in order to monitor the pH of the adhesive primer. The sodium hydroxide was added in a drop wise fashion and the pH allowed to stabilize between additions. The final pH was adjusted to approximately 8.5 to allow for latex stability and to let the modifier act to its fullest ability. After mixing for about thirty minutes, the final addition was the Butyl Carbitol, which was added with high mixing shear (about 700 RPM).

The coating was measured for viscosity and surface tension, which viscosity range was from about 120 to about 600 cP and which surface tension was from about 22 to about 30 mN/m.

Unfused toner images were made on a Xerox DocuColour-12 device using mechanical (conventional ground) toners (CMYK). Toner mass per unit area (TMA) for the color black was controlled to a value of 0.50±0.5 mg/cm² which is representative of a monolayer image. Sample images were made on the following papers:

TABLE 2
Papers for Sample Images

| Paper Name | Coated/Uncoated | Basis Weight |
|---|---|---|
| White McCoy Gloss Cover | Coated Paper | 100 pound |
| White McCoy Silk Cover | Coated Paper | 100 pound |

Sample images were fused on a fuser fixture, which is a xerographic fusing apparatus. Images were fused at a set temperature of approximately 185° C. and a process speed of about 30 m/min. A total of 50 feeder sheets were fed through the fuser prior to fusing the image to the substrate, in order to stabilize the oil rate to be from about 11 to about 13 μg per copy. Once the image passed through the fuser, the paper was attached to a lead sheet and fed through the lab coater at a speed of 30 m/min. The 140 lines per inch roll in the coater resulted in a coating thickness of approximately 5 microns (wet). The image was then placed on the belt of a UV system at a speed of approximately 100 ft/min. and allowed to dry under the heat generated by the UV lamp (about 38° C.). Under these conditions, the above formulation provided sufficient wetting to allow for a uniform coating over an oil coated, fused-toner image. Dry film thickness was from about 1.5 microns to about 2 microns thick (dry).

Glue was applied by heating it to a liquid state (about 140° C.) and then manually applying to either an uncoated paper or paper coated with adhesive primer using a draw down rod at a set speed. A corresponding piece of the same page was placed on top of the liquid glue and a sandwich formation was made. The sandwich was placed in a sealer under pressure of about 5 psi for a period of approximately 3 seconds and then allowed to cool. Paper tear (measure of gluability) was measured by manually separating the pieces of the sandwich and visually inspecting the results. 0% means that there was no paper fiber tear, which is not desired, and 100% means complete adhesion and tear, which is desired.

As can be seen from the table below, by applying the adhesive primer to either paper type, the ability of the glue to adhere to the paper was improved, thus increasing paper fiber tear.

TABLE 3
Paper Fiber Tear Values

| | Paper Fiber Tear with | Paper Fiber Tear with Oil & |
|---|---|---|
| Paper Name | Oil, No Coating (%) | Aqueous Coated (%) |
| White McCoy | 20 | 80 |
| Gloss Cover | | |
| White McCoy | 30 | 90 |
| Silk Cover | | |

It will be appreciated that various of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, and are also intended to be encompassed by the following claims.

What is claimed is:

1. A liquid adhesive primer applied to a substrate at least partially covered by a release agent, wherein the adhesive primer as applied comprises at least one latex emulsion, water, at least one amino alcohol or at least one alkali base, and at least one surfactant.

2. The adhesive primer as applied to a substrate according to claim 1, wherein the release agent is selected from the group consisting of functionalized silicone oil and nonfunctionalized silicone oil.

3. The adhesive primer as applied to a substrate according to claim 2, wherein the functional silicon oil comprises an amino component or a mercapto components as a functional component.

4. The adhesive primer as applied to the substrate according to claim 1, further comprising at least one viscosity modifier comprising an acrylic alkali swellable emulsion, an associative thickener or combinations thereof.

5. The adhesive primer as applied to the substrate according to claim 1, wherein the at least one latex emulsion is an acrylic emulsion, a styrene/acrylic emulsion, a polyester emulsion, or combinations thereof.

6. The adhesive primer as applied to the substrate according to claim 1, wherein the at least one latex emulsion is self-crosslinking and/or alkali soluble.

7. The adhesive primer as applied to the substrate according to claim 1, wherein the at least one surfactant is an anionic surfactant, a nonionic surfactant, a silicone surfactant, a fluorosurfactant or combinations thereof.

8. The adhesive primer as applied to the substrate according to claim 1, wherein the at least one latex emulsion is from about 40 weight percent to about 95 weight percent of the adhesive primer, the water is from about 30 weight percent to about 80 weight percent of the adhesive primer, the at least one amino alcohol or at least one alkali base is from about 1 weight percent to about 5 weight percent of the adhesive primer, and the at least one surfactant is from about 0.01 weight percent to about 7.99 weight percent of the adhesive primer.

9. The adhesive primer as applied to the substrate according to claim 1, wherein a total glass transition temperature of the at least one latex emulsion is from about 30° C. to about 95° C.

10. The adhesive primer as applied to the substrate according to claim 1, wherein the adhesive primer has a surface tension from about 22 mN/n to about 40 mN/m.

11. The adhesive primer as applied to the substrate according to claim 1, wherein the adhesive primer has a viscosity from about 50 cP to about 750 cP at approximately room temperature.

12. The adhesive primer as applied to the substrate according to claim 1, wherein the adhesive primer wet thickness as applied has a thickness of from about 2 μm to about 10 μm, and as dried has a thickness of from about 0.5 μm to about 5 μm.

13. The adhesive primer as applied to the substrate according to claim 1, wherein an adhesive at least partially covers the adhesive primer and a substrate at least partially covers covers the adhesive, such that a bound article is formed.

14. A method comprising:
transferring and fusing a dry toner based image to media in a fusing device capable of applying heat and pressure for a dwell time and requiring the application of release oil to control stripping of the imaged media from fuser roll surfaces of the fusing device,
applying a liquid adhesive primer to the at least partially covered substrate using a coating technology within a period of 50 milliseconds to 120 seconds from the time the imaged media exits the fuser and is subsequently dried to a dry film coating film, and
applying an adhesive onto the adhesive primer such that the adhesive is firmly adhered to the substrate,
wherein the adhesive primer that is applied comprises at least one latex emulsion, water, at least one amino alcohol or at least one alkali base, and at least one surfactant.

15. The method according to claim 14, wherein a release oil on copy rate ranges from about 0 to about 25 microliter per copy.

16. The method according to claim 14, further comprising applying a second substrate to the adhesive to form a bound article.

17. The method according to claim 16, wherein the second substrate may optionally have a toner image thereon.

18. The method according to claim 16, wherein the second substrate is bound to the substlate via the adhesive and the adhesive primer.

19. The method according to claim 14, wherein the adhesive primer has a surface tension from about 22 mN/m to about 40 mN/m.

20. The method according to claim 14, wherein the adhesive primer has a viscosity from about 50 cP to about 750 cP at approximately room temperature.

21. The method according to claim 14, wherein the adhesive primer thickness as applied has a wet thickness of from about 2 μm to about 10 μm, and as dried has a thickness of from about 0.5 μm to about 5 μm.

22. A method for forming a bound article comprising:
at least partially covering a first recording medium with an adhesive primer that when applied comprises at least one latex emulsion, water, at least one amino alcohol or at least one alkali base, and at least one surfactant,
at least partially covering the adhesive primer with an adhesive, and
wherein the adhesive is associated with a second recording medium or the second recording medium is applied to the adhesive such that the second recording medium is bound to the first recording medium via the adhesive primer and the adhesive.

23. The method according to claim 22, wherein the first recording medium is at least partially covered by a release agent.

24. The method according to claim 23, wherein the adhesive primer seals in the release agent.

25. The method according to claim 23, wherein the adhesive primer in the formed bound article has a thickness of from about 0.5 μm to about 5 μm.
